(19) United States
(12) Patent Application Publication
(10) Pub. No.: US 2025/0269717 A1
(43) Pub. Date: Aug. 28, 2025

(54) LID STRUCTURE FOR VEHICLE

(71) Applicant: MORIROKU TECHNOLOGY COMPANY, LTD., Tokyo (JP)

(72) Inventor: Takuya Kurokawa, Tokyo (JP)

(21) Appl. No.: 19/058,499

(22) Filed: Feb. 20, 2025

(30) Foreign Application Priority Data
Feb. 28, 2024 (JP) 2024-029034

(51) Int. Cl. B60K 15/05; B60L 53/16

(52) U.S. Cl. CPC B60K 15/05; B60L 53/16; B60K 2015/053

(57) ABSTRACT

A lid structure for a vehicle includes a shaft member located on a rear side of an exterior surface that is visible from an outside; a lid that is swingable about the shaft member to open and close an opening formed on the exterior surface; and a support member that rotatably supports the shaft member. The support member includes a fixing portion fixed to the rear side of the exterior surface. When viewed in a direction along the shaft member, the fixing portion is located on a side opposite to the opening with the shaft member as a center.

### FIELD OF THE INVENTION

The present invention relates to a lid structure for a vehicle.

### BACKGROUND

A fuel filler port or a charging port of a vehicle may be opened and closed by a lid device referred to as a fuel lid. As a conventional technique related to such a lid device, there is a technique disclosed in European Patent No. 1508465. The lid device is configured such that an opening formed in a vehicle body is opened and closed by a swingable lid.

According to the lid device disclosed in the above-described specification, when the lid is in a fully open state, an end portion of the lid is located in the vicinity of a design surface. In this state, for example, a person may unintentionally come into contact with the lid and apply a force in a direction to further open the lid. Then, the end portion of the lid comes into contact with the design surface, thereby peeling the paint on the design surface or causing scratches to the design surface, which is a concern. Improvements are desired not only for fuel lids, but also from the perspective of maintaining a high level of aesthetic appearance.

An object of the present disclosure is to provide a lid structure for a vehicle capable of maintaining a high level of aesthetic appearance.

### SUMMARY

According to the present disclosure, there is provided a lid structure for a vehicle including: a shaft member located on a rear side of an exterior surface that is visible from an outside; a lid that is swingable about the shaft member to open and close an opening formed on the exterior surface; and a support member that supports the shaft member. The support member includes a fixing portion fixed to the rear side of the exterior surface. When viewed in a direction along the shaft member, the fixing portion is located on a side opposite to the opening with the shaft member as a center.

According to the present disclosure, it is possible to provide the lid structure for a vehicle capable of maintaining a high level of aesthetic appearance.

### BRIEF DESCRIPTION OF THE DRAWINGS

FIG. 1 is a front view of a lid device in which a lid structure for a vehicle according to an embodiment is adopted;

FIG. 2 is a cross-sectional view taken along line 2-2 in FIG. 1;

FIG. 3 is a view when viewed in the direction of arrow 3 in FIG. 2;

FIG. 4 is a view describing a state where which a lid illustrated in FIG. 2 is fully opened; and

FIG. 5 is an enlarged view of portion 5 in FIG. 4.

### DETAILED DESCRIPTION

An embodiment of the invention will be described below based on the accompanying drawings. A mode illustrated in the accompanying drawings is one example, and the invention is not limited to the mode.

### EMBODIMENT

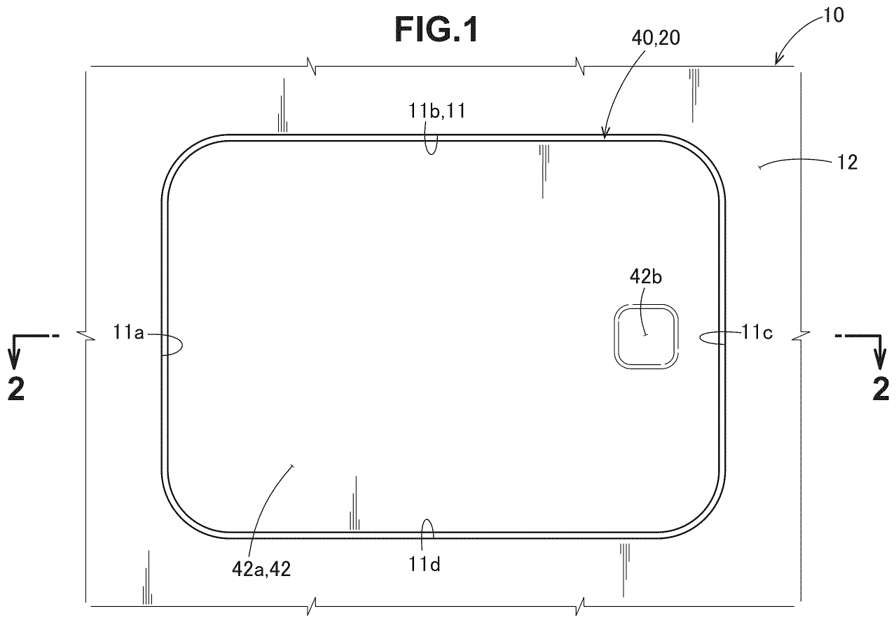

Referring to FIG. 1, FIG. 1 illustrates a lid device 20 for a vehicle (hereinafter, referred to as the “lid device 20”) that uses a lid structure for a vehicle. The lid device 20 is, for example, a fuel lid that opens and closes a fuel filler port or a charging port. The lid device 20 opens and closes an opening 11 formed in an exterior member 10 provided on a vehicle body.

The exterior member 10 is a component made of a resin material. The exterior member 10 is, for example, a front grille provided at the front of a vehicle. A surface on a vehicle exterior side of the exterior member 10 is referred to as an “exterior surface 12” that is visible from the outside. The opening 11 that is a substantially rectangular hole is formed in the exterior member 10.

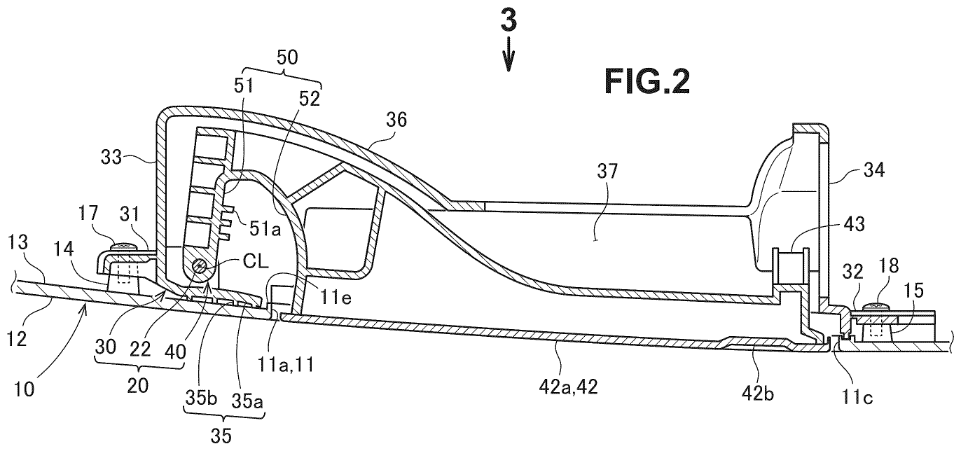

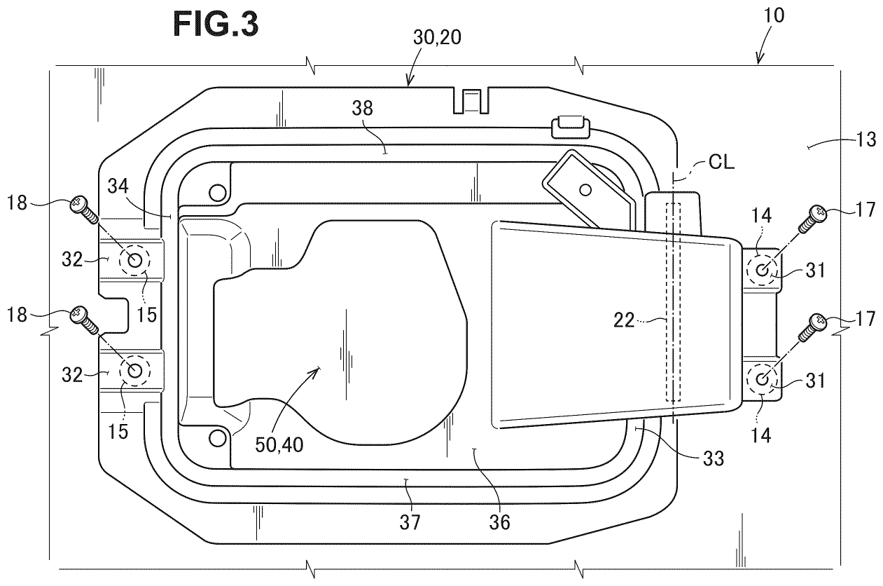

Referring to FIG. 2 and FIG. 3, a plurality of bosses 14 and 15 for fixing the lid device 20 are formed on an exterior rear surface 13 that is a surface located on a rear side of the exterior surface 12. The lid device 20 is fixed to the bosses 14 and 15 by screw fastening members 17 and 18 configured as screws.

Referring to FIG. 2, the lid device 20 includes a support member 30 fixed to the rear side of the exterior member 10; a shaft member 22 serving as a shaft supported by the support member 30; and a lid 40 supported by the shaft member 22 and capable of opening and closing the opening 11.

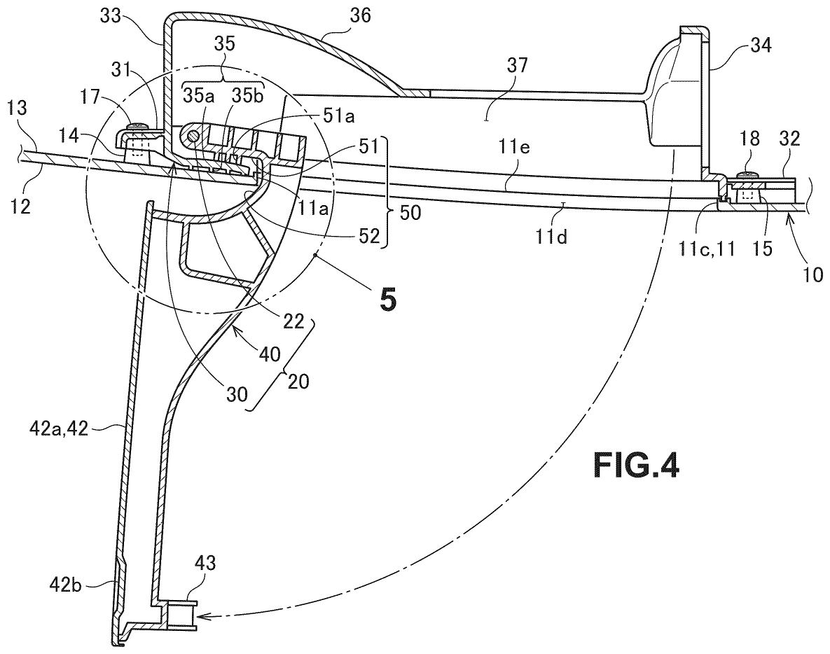

Referring to also FIG. 4, the lid 40 is swingable from a fully closed position illustrated in FIG. 2 to a fully open position illustrated in FIG. 4.

Referring to FIG. 1, edges of the opening 11 having a substantially rectangular shape, which correspond to the respective sides, are referred to as a first edge portion 11a, a second edge portion 11b, a third edge portion 11c, and a fourth edge portion 11d in order from the edge on the left side of the figure.

Referring to also FIG. 2, the first edge portion 11a and the third edge portion 11c extend substantially parallel to an extending direction of the shaft member 22, and the second edge portion 11b and the fourth edge portion 11d extend substantially perpendicular to the extending direction of the shaft member 22. The first edge portion 11a is located closer to the shaft member 22 than the third edge portion 11c, and the first edge portion 11a can be rephrased as a proximal edge 11a that is closest to the shaft member 22 among the first edge portion 11a to the fourth edge portion 11d. The third edge portion 11c is located farther from the shaft member 22 than the first edge portion 11a, and the third edge portion 11c can be rephrased as a distal edge 11c.

The shape of the opening 11 formed on the exterior surface 12 is not limited to a rectangular shape, and may be, for example, a circular shape. In the case of a circular opening, it is preferable that the “proximal edge” includes at least a portion of a circular edge which is closest to the shaft member 22.

The second edge portion 11b can be rephrased as a first perpendicular edge 11b extending perpendicular to the first edge portion 11a and the third edge portion 11c. The fourth edge portion 11d can be rephrased as a second perpendicular edge 11d extending perpendicular to the first edge portion 11a and the third edge portion 11c.

Referring to FIG. 2, of the bosses 14 and 15, the boss 14 formed in a portion closer to the first edge portion 11a is referred to as a first boss 14, and the boss 15 formed in a portion closer to the third edge portion 11c is referred to as a second boss 15. The first boss 14 is closest to the shaft member 22, and is farther from the proximal edge 11a than the shaft member 22. The second boss 15 is formed at a position farther from the shaft member 22 than the first boss 14.

Any type of screw such as a machine screw, a tapping screw, a cap bolt, or a bolt can be used as the screw fastening members 17 and 18. Of the screw fastening members 17 and 18, the screw fastening member 17 fastened to the first boss 14 is referred to as a first fastening member 17, and the screw fastening member 18 fastened to the second boss 15 is referred to as a second fastening member 18.

The support member 30 is configured as an integrally molded article. The support member 30 is a substantially box-shaped member that is open at a portion to which the lid 40 is attached. The support member 30 includes a first fixing portion 31 (fixing portion 31) fixed to the first boss 14; a second fixing portion 32 fixed to the second boss 15; a first side wall portion 33 connected to an end portion of the first fixing portion 31 and extending in a direction away from the exterior member 10; a second side wall 34 connected to an end portion of the second fixing portion 32 and extending in a direction away from the exterior member 10; a support member contact portion 35 that extends from an end portion (one end) of the first side wall 33, which is closer to the exterior member 10, along the rear surface of the exterior member 10, and that abuts against the exterior rear surface 13 of the exterior member 10; a rear wall 36 that connects an end portion (the other end) of the first side wall 33, which is farther from the exterior member 10, to an end portion (the other end) of the second side wall 34, which is farther from the exterior member 10; a bottom portion 37 that closes a lower end; and a ceiling portion 38 (refer to FIG. 3) that faces the bottom portion 37 and that closes an upper end.

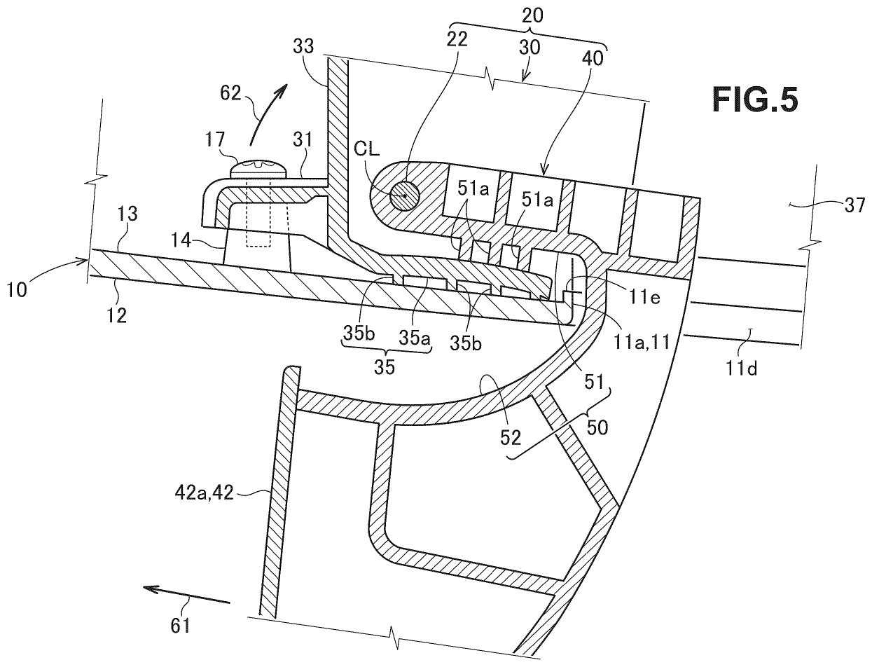

Referring to FIG. 5, the support member contact portion 35 includes a support member contact portion body 35a facing the exterior rear surface 13 and formed in an arch shape, and ribs 35b (support member-side ribs 35b) which extend from the support member contact portion body 35a toward the exterior rear surface 13, and of which the tips can come into contact with the exterior rear surface 13. A plurality of the ribs 35b are formed. Since the ribs 35b extend in the direction of an axis CL, deformation of the support member 30 in the direction of the axis CL can be suppressed.

Referring to FIG. 2, the lid 40 includes a lid body 50 made of resin and supported by the shaft member 22; a lid design portion 42 made of resin, supported by the lid body 50, and exposed to the outside of the vehicle; and a held portion 43 extending from a tip of the lid body 50 toward the support member 30 and held by a lock device (not illustrated) in a fully closed state.

The lid body 50 includes a lid contact portion 51 that extends from the shaft member 22 in a radial direction and that can come into contact with the support member 30 when the lid 40 is in the fully open position, and a connecting portion 52 that connects a tip of the lid contact portion 51 to an end portion on a proximal edge 11a side of the lid design portion 42.

Referring to FIG. 5, the lid contact portion 51 includes a plurality of ribs 51a (lid-side ribs 51a) of which the tips can abut against the support member 30 in a fully open state.

When viewed in the direction along the axis CL of the shaft member 22, the proximal edge 11a, the lid contact portion 51, the shaft member 22, and the fixing portion 31 are arranged in order with reference to a direction from the proximal edge 11a toward the first fixing portion 31, and the support member contact portion 35 and the lid contact portion 51 are spaced apart from the proximal edge 11a. In other words, the lid contact portion 51 (ribs 51a) and the shaft member 22 are located closer to a fixing portion 31 side than the proximal edge 11a. The lid contact portion 51 is located between the proximal edge 11a and the shaft member 22. In addition, the lid contact portion 51 and the support member contact portion 35 overlap each other in a direction orthogonal to the exterior surface 12.

The connecting portion 52 is formed in a curved shape so as not to abut against the proximal edge 11a when the lid 40 is displaced from the fully closed state to the fully open state. Furthermore, the lid contact portion 51 (ribs 51a) also does not abut against the proximal edge 11a when the lid 40 is displaced from the fully closed state to the fully open state. When the lid 40 that is in the fully open position is swung in a direction to further open the lid 40, the direction of a force applied to the support member 30 is substantially orthogonal to the exterior surface 12, a force in the opposite direction acts on the fixing portion 31 on a side opposite to the shaft member 22, so that the lid 40, the support member 30, and the exterior surface 12 move to rotate about the shaft member 22. Therefore, the lid 40 and the exterior surface 12 are less likely to come into contact with each other, so that the exterior surface 12 can be prevented from being scratched.

Referring to FIG. 1 and FIG. 2, a lid design surface 42a of the lid design portion 42, which is a surface exposed to the outside of the vehicle, is substantially continuous with the exterior surface 12 when the lid 40 is in the fully closed position. The lid design surface 42a has a substantially rectangular shape along the opening 11.

A part of the lid design surface 42a may be formed as a recess 42b formed in a slightly recessed shape compared to other portions. Accordingly, an operator can easily recognize a portion that has to be operated.

Referring to FIG. 5, when the lid 40 is in the fully open state, at least the end portion on the proximal edge 11a side of the lid design portion 42 is located at a portion farther from the proximal edge 11a than the shaft member 22.

The edges of the opening 11 are formed integrally with an opening protrusion 11e protruding toward the inside of the vehicle.

The lid structure for a vehicle adopted in the lid device 20 described above will be summarized below.

Referring to FIG. 2, in a first aspect, the lid structure for a vehicle includes the shaft member 22 located on the rear side of the exterior surface 12 that is visible from the outside; the lid 40 that is swingable about the shaft member 22 to open and close the opening 11 formed on the exterior surface 12; and the support member 30 that supports the shaft member 22. The support member 30 includes the first fixing portion 31 (fixing portion 31) fixed to the rear side of the exterior surface 12. When viewed in the direction along the shaft member 22 (with reference to a cross section extending in a circumferential direction with the shaft member 22 as a center), the first fixing portion 31 is located on the side opposite to the opening 11 with the shaft member 22 as a center.

Referring to FIG. 5, when the lid 40 that is in the fully open position is swung in the direction to further open the lid 40 as indicated by arrow 61, a portion of the first fixing portion 31 of the support member 30, the portion including the exterior surface 12, is pulled toward the rear side of the exterior surface 12 as indicated by arrow 62. Since the exterior surface 12 is displaced in a movement direction of the lid 40 in accordance with the displacement of the support member 30, the lid 40 and the exterior surface 12 are less likely to come into contact with each other, and the exterior surface 12 can be prevented from being scratched. It is possible to provide the lid structure for a vehicle capable of maintaining a high level of aesthetic appearance.

In a second aspect, in the lid structure for a vehicle according to the first aspect, the lid 40 includes the lid contact portion 51 capable of coming into contact with the support member 30 when the lid 40 is in the fully open position where the lid 40 is fully open. By bringing the lid contact portion 51 into contact with the support member 30, the direct application of a load to the portion including the exterior surface 12 is avoided.

In a third aspect, in the lid structure for a vehicle according to the second aspect, the lid contact portion 51 includes a rib 51a of which the tip is capable of coming into contact with the support member 30. The strength of the lid 40 can be increased by the rib 51a.

In a fourth aspect, in the lid structure for a vehicle according to any one of the first to third aspects, the support member 30 includes the support member contact portion 35 in contact with the rear side of the exterior surface 12. When a portion of the edge of the opening 11 of the exterior surface 12, the portion being closest to the shaft member 22, is defined as the proximal edge 11a, the support member contact portion 35 includes a rib 35b, of which the tip is capable of coming into contact with the rear side of the exterior surface 12, between the shaft member 22 and the proximal edge 11a. The strength of the support member 30 around the shaft member 22 is increased.

In a fifth aspect, in the lid structure for a vehicle according to the fourth aspect, the lid 40 includes the lid contact portion 51 capable of coming into contact with the support member 30 when the lid 40 is in the fully open position where the lid 40 is fully open. The support member contact portion 35 is sandwiched between the lid contact portion 51 and the rear side of the exterior surface 12 on the rear side of the exterior surface 12 when the lid 40 is in the fully open position. By causing the lid contact portion 51 to abut against a portion with high strength, the life span of the lid device 20 to which the lid structure for a vehicle is applied can be extended.

In a sixth aspect, in the lid structure for a vehicle according to any one of the first to fifth aspects, when viewed in the direction along the axis CL of the shaft member 22, the proximal edge 11a, the lid contact portion 51, the shaft member 22, and the first fixing portion 31 are arranged in order with reference to the direction from the proximal edge 11a toward the fixing portion 31. The support member contact portion 35 and the lid contact portion 51 are spaced apart from the proximal edge 11a. In other words, the lid contact portion 51 (rib 51a) and the shaft member 22 are located closer to the fixing portion 31 side than the proximal edge 11a. The lid contact portion 51 is located between the proximal edge 11a and the shaft member 22. A load on the lid 40 acts as a force that pulls the exterior surface 12 in the vicinity of the fixing portion 31 toward the rear side of the exterior surface 12 with the shaft member 22 as an axis.

In a seventh aspect, in the lid structure for a vehicle according to any one of the first to sixth aspects, the exterior surface 12 is a part of the exterior member 10 (for example, a front grille) that is fixable to the vehicle body. Since the exterior member 10 can be fixed to the vehicle body, the support member 30 can be fixed to the exterior member 10 in advance, and then the exterior member 10 can be fixed to the vehicle body.

The exterior member 10 (exterior surface 12) is not recessed from an opening end into the opening (in the direction away from the exterior surface 12). In other words, the exterior member 10 does not wrap around to a rear side of the lid 40 (lid design portion 42), and does not overlap the lid 40. Therefore, the shaft member 22 can be brought closer to the exterior surface 12. Accordingly, the connecting portion 52 of the lid 40 does not become large and can be connected near the end of the lid design portion 42, so that high rigidity of the lid 40 can be ensured. In addition, when the connecting portion 52 is made compact, the amount of bending of the lid 40 can be suppressed, and interference with and scratches to the exterior surface 12 can also be prevented.

In an eighth aspect, in the lid structure for a vehicle according to any one of the first to seventh aspects, the support member 30 includes the first fixing portion 31 fixed to the exterior member 10. The first fixing portion 31 is fixed to the exterior member 10 by the first screw fastening member 17 (screw fastening member 17).

Screw fastening provides high axial force and excellent pulling force for the exterior surface 12 (when the support member 30 is shifted in the direction of the rear side of the exterior surface 12, the exterior surface 12 bends in the direction of the rear side, together with the support member 30). Therefore, interference between the exterior surface 12 and the lid 40 can be prevented, and the exterior surface 12 can be prevented from being scratched. In addition, screw fastening can be performed more easily than other fastening methods such as welding.

An example in which the lid structure for a vehicle according to the invention is applied to a fuel lid has been described; however, the lid device 20 is not limited to being provided in the exterior member 10 fixed to the vehicle body, and may be provided in a component inside a passenger compartment. When the lid device 20 is provided inside the passenger compartment, the outside from which the exterior surface 12 is visible refers to a surface that is visible to occupants inside the passenger compartment.

The invention is not limited to the embodiment as long as the actions and effects of the invention are exhibited.

What is claimed is:

1. A lid structure for a vehicle, comprising:
a shaft member located on a rear side of an exterior surface that is visible from an outside;
a lid that is swingable about the shaft member to open and close an opening formed on the exterior surface; and
a support member that supports the shaft member,
wherein the support member includes a fixing portion fixed to the rear side of the exterior surface, and
when viewed in a direction along the shaft member, the fixing portion is located on a side opposite to the opening with the shaft member as a center.

2. The lid structure for a vehicle according to claim 1,
wherein the lid includes a lid contact portion capable of coming into contact with the support member when the lid is in a fully open position where the lid is fully open.

3. The lid structure for a vehicle according to claim 2,
wherein the lid contact portion includes a rib of which a tip is capable of coming into contact with the support member.

4. The lid structure for a vehicle according to claim 1,
wherein the support member includes a support member contact portion in contact with the rear side of the exterior surface, and
when a portion of an edge of the opening of the exterior surface, the portion being closest to the shaft member, is defined as a proximal edge, the support member contact portion includes a rib, of which a tip is capable of coming into contact with the rear side of the exterior surface, between the shaft member and the proximal edge.

5. The lid structure for a vehicle according to claim 2,
wherein the support member includes a support member contact portion in contact with the rear side of the exterior surface, and
when a portion of an edge of the opening of the exterior surface, the portion being closest to the shaft member, is defined as a proximal edge, the support member contact portion includes a rib, of which a tip is capable of coming into contact with the rear side of the exterior surface, between the shaft member and the proximal edge.

6. The lid structure for a vehicle according to claim 3,
wherein the support member includes a support member contact portion in contact with the rear side of the exterior surface, and
when a portion of an edge of the opening of the exterior surface, the portion being closest to the shaft member, is defined as a proximal edge, the support member contact portion includes a rib, of which a tip is capable of coming into contact with the rear side of the exterior surface, between the shaft member and the proximal edge.

7. The lid structure for a vehicle according to claim 5,
wherein the support member contact portion is sandwiched between the lid contact portion and the rear side of the exterior surface when the lid is in a fully open position.

8. The lid structure for a vehicle according to claim 6,
wherein the support member contact portion is sandwiched between the lid contact portion and the rear side of the exterior surface when the lid is in a fully open position.

9. The lid structure for a vehicle according to claim 5,
wherein when viewed in the direction along the shaft member, the proximal edge, the lid contact portion, the shaft member, and the fixing portion are arranged in order with reference to a direction from the proximal edge toward the fixing portion, and
the support member contact portion and the lid contact portion are spaced apart from the proximal edge.

10. The lid structure for a vehicle according to claim 6,
wherein when viewed in the direction along the shaft member, the proximal edge, the lid contact portion, the shaft member, and the fixing portion are arranged in order with reference to a direction from the proximal edge toward the fixing portion, and
the support member contact portion and the lid contact portion are spaced apart from the proximal edge.

11. The lid structure for a vehicle according to claim 7,
wherein when viewed in the direction along the shaft member, the proximal edge, the lid contact portion, the shaft member, and the fixing portion are arranged in order with reference to a direction from the proximal edge toward the fixing portion, and
the support member contact portion and the lid contact portion are spaced apart from the proximal edge.

12. The lid structure for a vehicle according to claim 8,
wherein when viewed in the direction along the shaft member, the proximal edge, the lid contact portion, the shaft member, and the fixing portion are arranged in order with reference to a direction from the proximal edge toward the fixing portion, and
the support member contact portion and the lid contact portion are spaced apart from the proximal edge.

13. The lid structure for a vehicle according to claim 1,
wherein the exterior surface is a part of an exterior member that is fixable to a vehicle body.

14. The lid structure for a vehicle according to claim 13,
wherein the fixing portion is fixed to the exterior member by a screw fastening member.
